(19) United States
(12) Patent Application Publication
(10) Pub. No.: US 2003/0042438 A1
(43) Pub. Date: Mar. 6, 2003

(54) Methods and apparatus for sensing degree of soiling of currency, and the presence of foreign material

(76) Inventors: Nabil M. Lawandy, North Kingstown, RI (US); John A. Moon, Wallingford, CT (US)

Correspondence Address: HARRINGTON & SMITH, LLP, 4 RESEARCH DRIVE, SHELTON, CT, 06484-6212, US

(21) Appl. No.: 09/945,427

(22) Filed: Aug. 31, 2001

(51) Int. Cl. G06K 5/00

(52) U.S. Cl. 250/556

(57) ABSTRACT

A method and system are disclosed for detecting an amount of soiling of a bill. The method includes steps of (A) illuminating at least a portion of the bill with excitation light; in response to the excitation light, (B) emitting response light from the portion of the bill; (C) detecting an intensity of the emitted response light; and (D) correlating the detected intensity with an amount of soiling of the bill. The method can include a further step of (E) correlating the amount of soiling with an amount of wear of the bill, and may also further include a step of (F) detecting a presence of a substantially specular surface region on the bill, indicating a presence of a foreign substance, such as a piece of transparent or semi-transparent tape. Also disclosed is a method and system for detecting a presence of a foreign substance on a surface of a bill. The method includes steps of (A) illuminating at least a portion of the bill with light; in response to the light, (B) causing either a specular reflection or a diffuse reflection from a surface of the bill; (C) detecting a presence of a specular reflection; and (D) correlating the detected specular reflection with the presence of a foreign substance, such as tape, on the bill. An amount of polarization contrast can also be determined for detecting a presence of foreign matter, such as tape, on the surface of the bill.

### FIELD OF THE INVENTION

This invention relates generally to systems and methods for handling currency and other types of documents, and more particularly relates to high speed currency inspection techniques.

### BACKGROUND OF THE INVENTION

As paper money, referred to herein generally as currency, notes, or as bills, is circulated and used it becomes soiled and worn. One result of the wear process is that the original stiffness of the paper stock is lost, which in turn results in a difficulty in the mechanical counting, sorting and handling of the bills. Difficulties also arise when inserting the bills into validators, changers and the like. In fact, after a significant amount of soiling and wear occurs many automatic bill validators and bill changers may simply reject the bill.

In the United States of America the Department of the Treasury monitors circulating currency in order remove from circulation those bills whose degree of soiling and/or wear reaches some threshold level. Also removed are torn bills, incomplete bills, and bills having tape or some other foreign material adhering thereto. Due to the vast amount of currency that is in circulation, it can be appreciated that this monitoring process needs to be carried out quickly and reliably, ideally as an automatic process with little or no human involvement.

One currently employed method for automatically monitoring currency uses an imaging technique, wherein an image is made of the note, and the image is then subjected to image processing algorithms to determine a degree of soiling. The determined degree of soiling is then correlated with an amount of wear and “limpness”, enabling well-circulated bills to be identified and removed from circulation.

While being generally effective, this technique relies on complex hardware and software and, as a result, its throughput may be less than desired. Also, it is possible that a relatively unsoiled note may have transparent tape or some other transparent material adhering thereto, and the presence of this foreign material may not be detected by the image processing software.

### OBJECTS AND ADVANTAGES OF THE INVENTION

It is a first object and advantage of this invention to provide an improved technique for examining currency that overcomes the foregoing and other problems.

It is a further object and advantage of this invention to provide a high speed, simplified technique for determining a degree of soiling of a bill, thereby enabling a more rapid correlation to be made with limpness and wear.

It is a another object and advantage of this invention to provide a high speed, simplified technique for determining a degree of soiling of a bill, and which furthermore is capable of detecting the presence of transparent or substantially transparent foreign matter, such as clear tape, which may be adhering to a bill.

### SUMMARY OF THE INVENTION

The foregoing and other problems are overcome and the objects of the invention are realized by methods and apparatus in accordance with embodiments of this invention.

A method and system are disclosed for detecting an amount of soiling of a bill. The method includes steps of (A) illuminating at least a portion of the bill with excitation light; in response to the excitation light, (B) emitting response light from the portion of the bill; (C) detecting an intensity of the emitted response light; and (D) correlating the detected intensity with an amount of soiling of the bill. The method can include a further step of (E) correlating the amount of soiling with an amount of wear of the bill, and may also further include a step of (F) detecting a presence of a substantially specular surface region on the bill, indicating a presence of a foreign substance, such as a piece of transparent or semi-transparent tape. Preferably the steps of illuminating and emitting are executed while performing a step of conveying the bill past an optical radiation source and an optical radiation detector. The step of correlating employs a prestored set of data obtained from a set of reference notes.

The step of emitting includes a step of generating light having a longer wavelength or a shorter wavelength with a structure embedded within the bill or disposed on or within a surface of the bill.

Also disclosed is a method and system for detecting a presence of a foreign substance on a surface of a bill. The method includes steps of (A) illuminating at least a portion of the bill with light; in response to the light, (B) causing either a specular reflection or a diffuse reflection from a surface of the bill; (C) detecting a presence of a specular reflection; and (D) correlating the detected specular reflection with the presence of a foreign substance, such as tape, on the bill. This method may further include a step of detecting the presence of soiling of the bill, as described above.

An amount of polarization contrast for light reflecting from a surface of a substrate, such as an item of currency, can also be determined for detecting or correlating with a presence of foreign matter, such as tape, on the surface.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is an enlarged, cross-sectional view (not to scale) of a bill having a first embodiment of imbedded objects capable of generating a stimulated emission;

FIG. 2 is an enlarged, cross-sectional view (not to scale) of a bill having a second embodiment of imbedded objects capable of generating a stimulated emission;

FIG. 3 is an enlarged, cross-sectional view (not to scale) of a bill having a first embodiment of a surface object capable of generating a stimulated emission;

FIG. 4 is an enlarged, cross-sectional view (not to scale) of a bill having a second embodiment of a surface object or region capable of generating a stimulated emission;

FIG. 5A is a graph depicting stimulated emission intensity reference data for a new bill, a partially soiled bill and a heavily soiled bill;

FIG. 5B is a simplified block diagram of a currency inspection system in accordance with an embodiment of this invention, that employs the reference data of FIG. 5A in determining whether to reject or accept a bill;

FIG. 6A is a two-dimensional view of specular and diffuse rays leaving a surface;

FIG. 6B is a three-dimensional view of specular rays of a given polarization reflected by a reflecting surface;

FIG. 7 is a schematic diagram of a first embodiment of an apparatus for measuring scattering angles according to the present invention;

FIG. 8 is a graph depicting scattering angles;

FIG. 9 is a schematic diagram of a second embodiment of an apparatus for measuring scattering angles for a beam of polarized light according to the present invention;

FIG. 10 is a graph of scattering angles taken with “p” incident polarization;

FIG. 11 is a graph showing a polarization contrast that could be expected for a bill having transparent tape adhering to one surface;

FIG. 12A is a plan view of a third embodiment of an apparatus for measuring scattering angles according to the present invention;

FIG. 12B is a side view of the third embodiment of an apparatus for measuring scattering angles according to the present invention;

FIG. 13 is a logic flow diagram in accordance with a first embodiment of this invention; and

FIG. 14 is a logic flow diagram in accordance with a second embodiment of this invention.

### DETAILED DESCRIPTION OF THE INVENTION

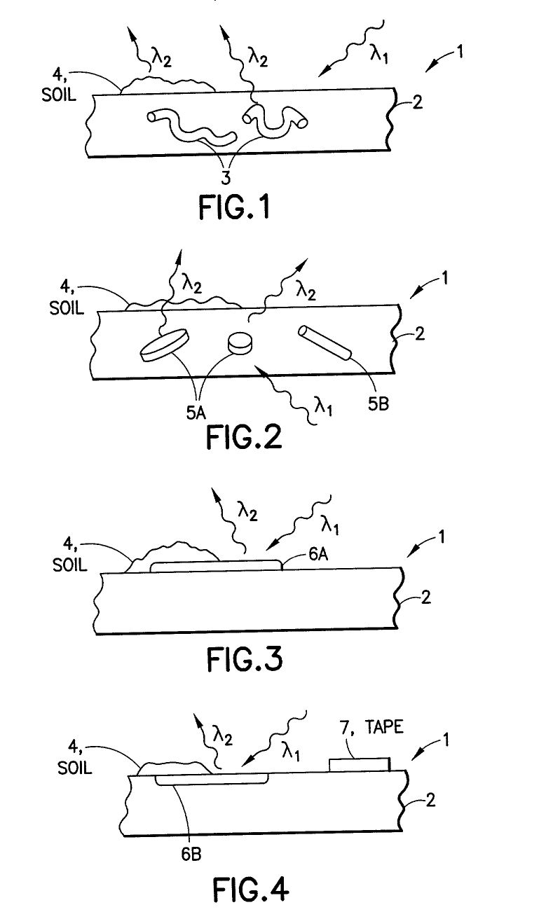

Reference is made to FIGS. 1-4, 5A and 5B for explaining a currency inspection system in accordance with a first embodiment of this invention.

It is first noted that a note or bill 1, such as a $100 bill issued by the United States Treasury, is described herein as comprising a paper stock 2. It is to be understood that the term “paper stock” is intended to encompass whatever material is suitable for use as a substrate material for printing currency and other types of documents of interest, and may thus include various materials, such as textile fibers, that are not “paper” per se. Some papers may have a significant rag content, and thus comprise a large amount of textile material. The term “paper” is also not intended to be limited to only a material derived from wood pulp, as it is well known that certain papers are derived from other plant materials, such as rice, bamboo and papyrus, as well as from synthetic materials.

This first embodiment of the invention arises from a realization by the inventors that by exposing the bill 1 to electromagnetic excitation radiation having first wavelengths (lambda 1) from an optical source 8, such as a Xenon flashlamp, that a stimulated emission (lambda-2, also referred to herein as response light) from certain material or objects 3, 5A, 5B, 6A, 6B located within or upon the paper stock 2 can be detected with a detector 9, and an intensity of the stimulated emission can then be associated or correlated by a suitable data processor 10A (such as a microprocessor) with an amount of soil 4 on a surface of the bill 1. Having determined an amount of soiling of the bill 1, one can thereafter associate or correlate the amount of soiling with an amount of wear, or a degree of “limpness”, of the bill 1. This embodiment of the invention thus avoids a requirement to use a camera to image the bill 1, and thereafter process the image with image processing software.

In the context of this invention the phrase “stimulated emission” encompasses any fluorescence or phosphorescence coming from materials embedded in or disposed upon currency, as opposed to a more conventional definition which generally would require laser illumination for these types of materials.

FIG. 1 depicts fiber-like structures 3 that are embedded in the paper stock 2. The fiber-like structures 3 are constructed from, or are coated with, a material, such as semiconductor material, that generates the stimulated emission at lambda-2 when excited or pumped with light having the wavelengths lambda-1. Various dyes can be used as well, as can a number of suitable fluorescent materials. It can be seen that an amount of the stimulated emission at lambda-2 leaving the surface of the bill 1 is different for an unsoiled portion of the bill 1, as compared to the soiled portion 4. The soiled portion 4 absorbs some amount of the incident light at lambda-1 and/or the emitted light at lambda-2, thereby decreasing the amount of light at lambda-2 that is available to be detected.

As is shown in FIG. 5A, measurements can be made on some set of reference bills, including new (unsoiled) bills, bills that are moderately or partially soiled, and bills that are heavily soiled. While three different categories of bill soiling are depicted in FIG. 5A, it can be appreciated that two categories could be used (i.e., soiled and unsoiled), or a greater number of categories can be established. The established set of reference data 11 is stored in a memory 10B coupled to the data processor 10A, and is used in making bill reject or acceptance decisions.

FIG. 2 depicts exemplary disk-shaped structures 5A (planchettes) and rod-shaped structures 5B that are embedded in the paper stock 2. These structures 5A and 5B are also constructed from, or are coated with, a material, such as semiconductor material, that generates the stimulated emission at lambda-2 when excited or pumped with light having the wavelengths lambda-1. Note that in FIG. 2 the source or pump light is applied from the lower surface of the bill 1, and the stimulated emission can be detected from the upper surface. Note also again that the soiled region 4 attenuates some portion of the stimulated emission at lambda-2.

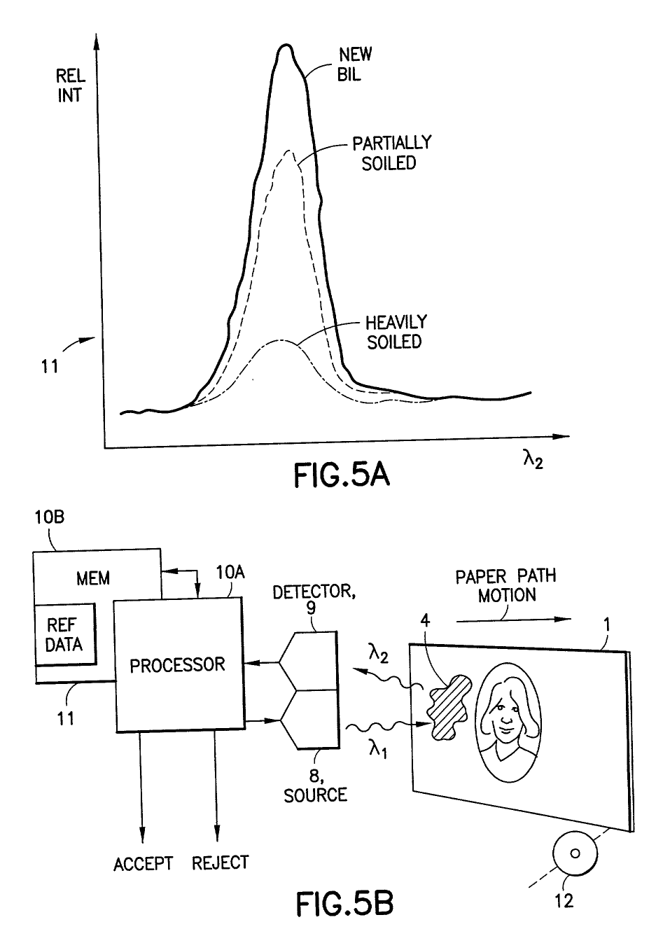

FIG. 3 depicts an exemplary structure 6A that is disposed upon a surface of the paper stock 2, while FIG. 4 depicts an exemplary structure or region 6B disposed within the surface. The region 6B could be, by example, an ink imprinting or embossing, wherein the ink is selected to have fluorescent properties when excited or pumped with light having the wavelengths lambda-1.

The system shown in FIG. 5 includes the above mentioned components, and further preferably includes some suitable type of conveyor 12, such as sets of rollers, for imparting a relative motion between a bill 1 being examined and the optical source 8 and detector 9. The conveyor 12 thus established a paper path, which can be linear and/or curved, as described below in relation to the tape-detecting embodiments. The processor 10A monitors the output of the detector 9 and compares the measured intensity of lambda-2 with the set of reference data 11 stored in the memory 10B. A decision is then made on the degree of soiling of the bill 1. The accept or reject decision may be made based solely on this decision, or the degree of soiling could be further correlated with a degree of wear and limpness of the bill 1, as established by a second set of reference data (not shown).

As was noted above for the embodiment of FIG. 2, the source 8 and the detector 9 could be disposed on opposite sides of the bill 1.

It should further be noted that while the structures or regions 3, 5A, 5B, 6A, 6B may have fluorescent optical properties, wherein lambda-2 is longer than lambda-1, in other embodiments a suitable up-conversion material can be used. Another suitable material is one known as LaserPaint™, which is described in, for example, U.S. Pat. Nos. 5,448,582 and 5,434,878.

Also, the source 8 could be a pulsed or a continuous source, and its emission can be scanned over the bill 1 or held stationary. The source 8 may also be comprised of a plurality of sources (e.g., a linear arrangement of LEDs or laser diodes) or an apertured mask for selectively passing light from, for example, a Xenon or a mercury arc strobe light. A laser could be used as well.

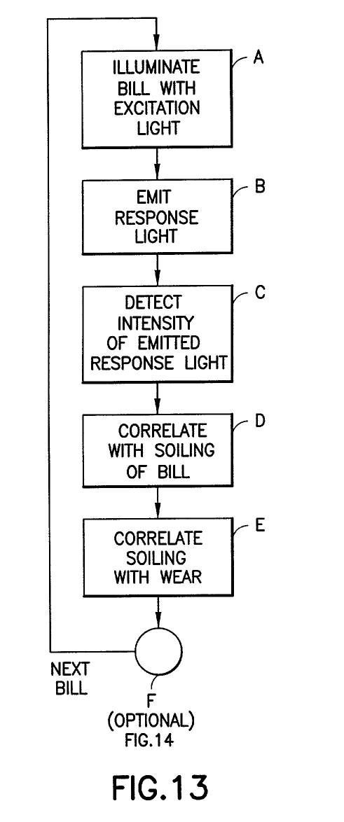

Referring to FIG. 13, a method in accordance with this first embodiment of the invention includes steps of (A) illuminating at least a portion of the bill 1 with excitation light (lambda-1); in response to the excitation light, (B) emitting response light (lambda-2) from the portion of the bill 1; (C) detecting an intensity of the emitted response light; and (D) correlating the detected intensity with an amount of soiling of the bill. The method can include a further step of (E) correlating the amount of soiling with an amount of wear of the bill, and may also further include a step of (F) detecting a presence of a substantially specular surface region on the bill for indicating a presence of a foreign substance, such as a piece of transparent or semi-transparent tape (as described in further detail below).

A second embodiment of this invention, which can be used separately from or combined with the bill soiling and wear testing system of FIG. 5, is used to detect a presence of a shiny and/or a transparent tape 7 (see FIG. 4) or some other shiny, or transparent, or semi-transparent foreign material (e.g., lacquer or fingernail polish), on the surfaces of the bill 1. It is noted that an opaque or substantially opaque matte tape can be detected by the embodiment of FIG. 5, as an opaque matte tape (e.g., certain types of electrical tape and packing tape) will strongly absorb the stimulated emission at lambda-2. However, some opaque tapes have a smooth, shiny surface characteristic, and may thus give rise to detectable specular reflections, as described in detail below.

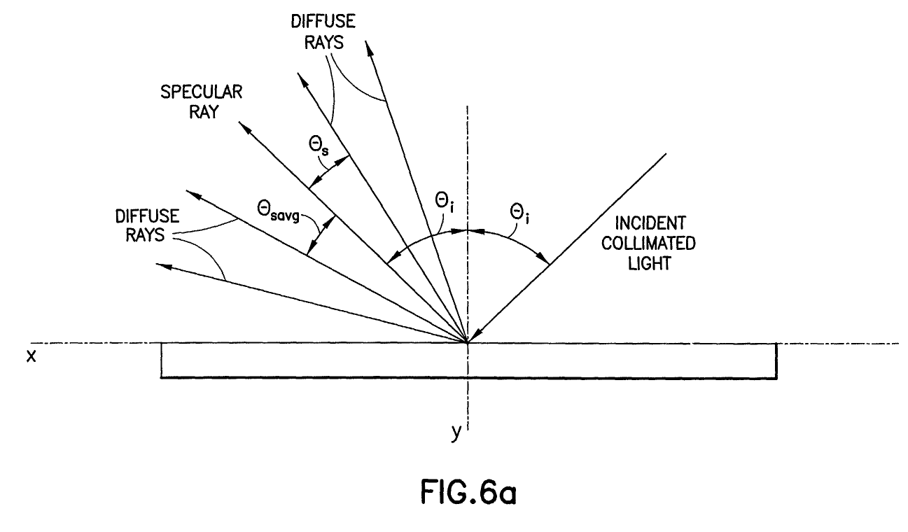

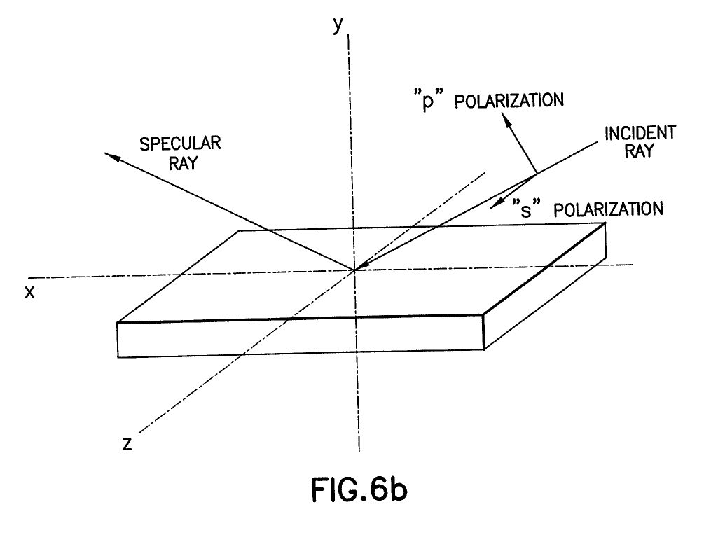

By way of introduction, FIGS. 6A and 6B illustrate typical properties of light rays when the light rays impinge on and leave a surface. FIG. 6A shows that one effect of impinging light on a surface is that the angle of the light rays may change giving rise to a diffuse component and a specular component of light leaving the surface. Impinging light on a surface that is “shiny” (e.g., taped with a smooth transparent or semi-transparent tape 7) results in a large specular component. The specular component is composed of rays which leave the surface at the same angle at which they impinge on the surface. On the contrary, impinging light on a surface which is “dull” (e.g., the surrounding surface of the paper stock 2) results in a large diffuse component leaving the surface. Diffuse components are characterized by a large range of scattering angles for light leaving the surface.

In FIGS. 6A and 6B, a collimated beam is shown impinging on a surface. In particular, FIG. 6A shows the specular and diffuse components of the collimated beam leaving the surface. In FIG. 6A, the incident collimated light impinges on the surface at an angle θᵢ, therefore the specular component leaves the surface at the same angle θᵢ. The diffuse components of the collimated beam, however, leaves the surface at different angles. The different angles are represented on FIG. 6A by an angle θₛ, which is an angle between the diffuse component and the specular component. Thus, θₛ represents the various scattering angles for light scattered from the surface.

As discussed above, the paper stock 2 of a bill 1 may have clear plastic tape 7 or some other transparent or semi-transparent material adhering to a surface thereof, making this portion of the bill's surface a substantially specular surface. Therefore, an incident light ray impinging the reflective taped portion 7 of the paper stock 2 produces a large component of specular light, while an incident light ray impinging on the untaped portion of the paper stock 2 produces a larger diffuse component.

Thus, by measuring the angular scattering of the rays leaving the surface, i.e. each θₛ as shown in FIG. 6A, certain characteristics of the surface of the bill 1 are determined. For example, a small average scattering angle of, for example about 1 degree, is characteristic of a specular surface area (e.g., a taped surface area), while a larger average scattering angle of, for example about 5 to 10 degrees, is characteristic of the normal surface of the paper stock 2.

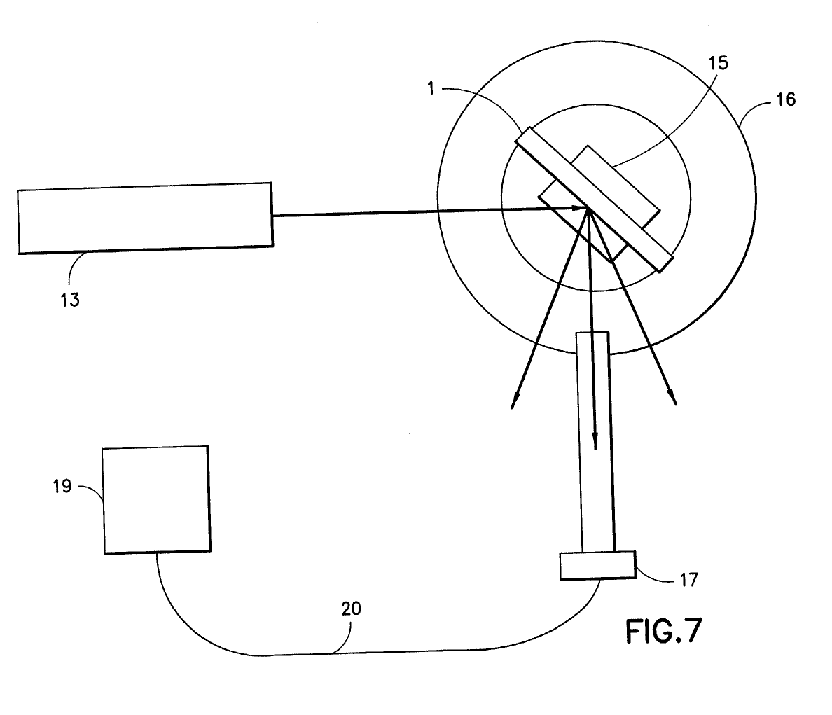

FIG. 7 illustrates a plan view of an apparatus for evaluating the scattering angles of light leaving one or more locations on the surface of the bill 1. The apparatus includes a light source such as a laser diode 13, a mount 15 to hold the bill 1, a rotation stage 16 with a fiber optic receiver 17 mounted to an arm of the stage, and a remote detector 19.

The laser diode 13 emits a beam of light which impinges on the one or more locations of the bill 1. As the stage 16 is rotated, a portion of the light impinging on the one or more locations of the bill 1 is detected by the fiber optic receiver 17 as it leaves the surface. The fiber optic receiver 17 passes the detected portion of light to the remote detector 19 via a fiber optic coupling, for example, a fiber optic cable 20. The remote detector 19 monitors the detected portion of light and measures the angular scattering of the detected portion of light leaving the one or more locations of the bill 1. In this way, the detected portion of the light leaving the bill 1 is measured at a number of different angles.

It is noted that the portion of light detected by the fiber optic receiver 17 increases as the angle of reflectance converges on the angle of incidence. Similarly, the portion of light detected decreases as the angle of reflectance diverges from the angle of incidence. Therefore, in a more specular surface the detected portion of light leaving the one or more locations of the surface of the bill 1 is concentrated about angles substantially equal to the angle of incidence at which the emitted beam of light impinges on the one or more locations of the bill 1.

It is also noted that the apparatus of FIG. 7 and the scattering angles detected leaving the one or more locations of the bill I are used to determine, for example, an average scattering angle, θ_{savg}, of the one or more locations of the bill 1. Alternatively, θ_{savg} of each of a plurality of locations maybe compared to other locations. This relative comparison of θ_{savg} values may then be used to identify each of the more than one locations as either as a taped location or an untaped location.

The relative difference in the average scattering angles, θ_{savg}, for taped and untaped surface locations can be determined for a set of reference bills. A relative difference in average scattering angles between the taped and untaped locations may be greater than about 5 degrees.

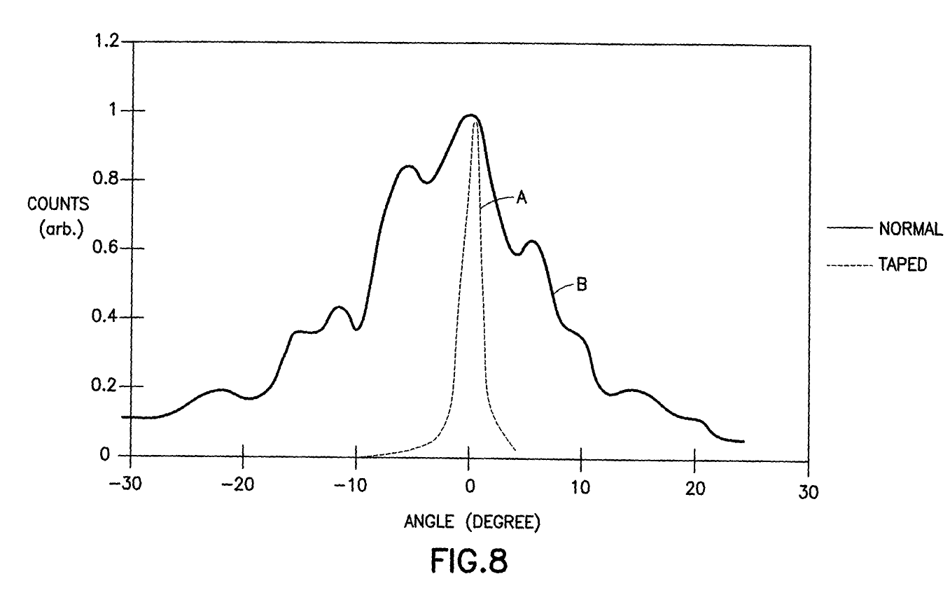

In FIG. 8, expected scattering angles detected from light leaving a location of a representative bill are graphically shown. In particular, FIG. 8 illustrates that a substantial change in the average scattering angle θ_{savg} may be seen between the two plotted signals. The first plotted signal, labeled “A”, represents the expected reflection characteristics of a reflective, taped location of the bill 1. The second plotted signal, labeled “B”, represents the reflection characteristics of the normal paper surface of the bill 1. As is illustrated in FIG. 8, and as discussed above, it can be appreciated that the average scattering angle, θ_{savg}, for the taped location is concentrated about angles substantially equal to the angle of incidence of the collimated beam, and therefore values of θ_{savg} are measured to be substantially equal to 0°.

The specular reflection from the taped location on the surface of the bill 1 may give a reflection on the order of 50-100 times that of the diffuse reflection from the regular paper surface. It is assumed that a remote detector 19 for the apparatus of FIG. 7 is typically a commercially inexpensive camera. The information detected by most inexpensive, commercially available cameras is converted to a digital number represented by, for example, 8-bits. Therefore, most inexpensive, commercially available cameras have 8-bits of dynamic range, e.g., the digital number is an 8-bit number. That is, that by employing a camera with 8-bits of dynamic range, signals separated in amplitude by more than a factor of 256, i.e. two to the eighth power (2⁸), can not be resolved. For example, if the sensitivity of a camera is set to detect signals of a first amplitude, then signals of a second, larger amplitude would saturate a digital converter within the camera if the second amplitude was more than a factor of 256 greater than the first amplitude. Conversely, if the sensitivity of the camera is set to detect signals of the second, larger amplitude, then signals of the smaller, first amplitude that were more than a factor of 256 less than the second amplitude would not be detected at all. Ideally, as can be appreciated from the above discussion, the signals to be detected should be of comparable amplitudes.

If the signals to be detected are not of comparable amplitudes, then one may measure the scattering angles of both the taped and untaped locations by adjusting the illumination intensity between the measurements of the taped and untaped locations. For example, the illumination intensity may be adjusted during separate angular scans, or multiple cameras may be provided for evaluating different illumination intensities at different wavelengths. The use of either separate scans or multiple cameras, however, may not be desirable for some applications.

More generally, the difference in intensities between the specular and the diffuse reflections coming from plastic tape and paper, respectively, exceeds the dynamic range of most inexpensive CCD cameras. In order to reduce the difference in reflected intensities one may preferentially reduce the specular intensity using a polarizer. This is possible because the specular reflection largely retains the polarization state of the incident beam, while the diffuse reflection does not.

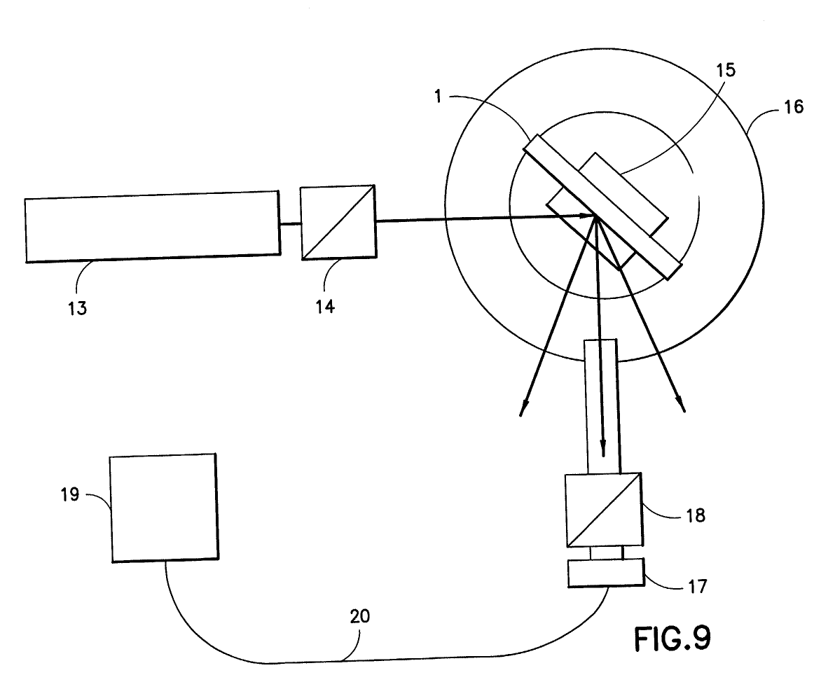

It has been determined that by adding a first polarizer 14 and a second polarizer 18 to the apparatus of FIG. 7, the dynamic range of measurements for the specular and the diffuse reflections can be brought within the 8-bit range of conventional cameras. Thus, in FIG. 9 an apparatus is shown wherein the first polarizer 14 and the second polarizer 18 are inserted into the illuminating light path of the laser 13, at points before and after the bill 1. Optionally, the first polarizer 14 and the second polarizer 15 may be variable or rotatable polarizers.

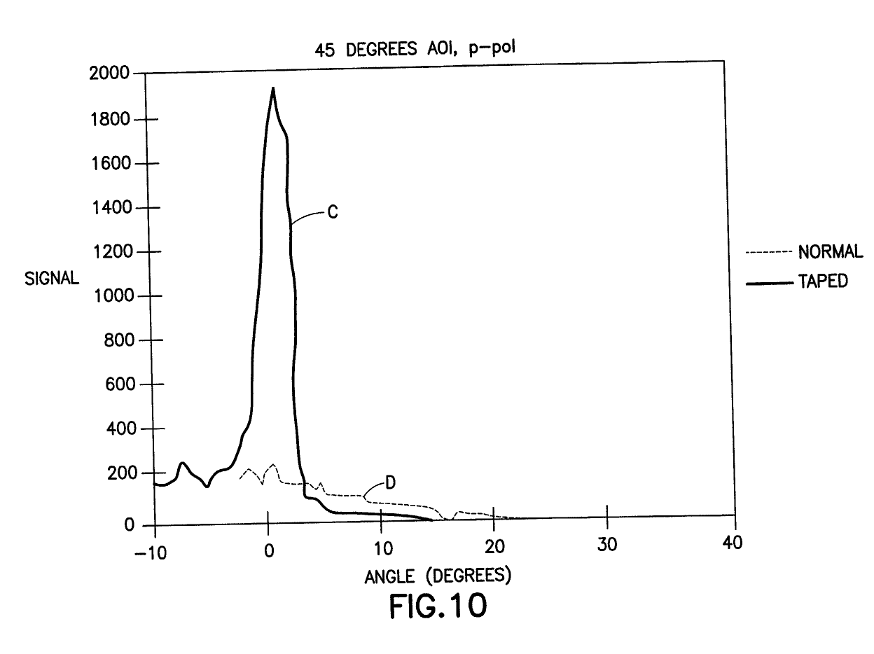

The apparatus of FIG. 9 measures the scattering angles of the polarized light detected leaving one or more locations on the surface of the bill 1. The measured scattering angles of the polarized light are evaluated to identify the one or more locations under evaluation as either taped or untaped locations. Exemplary angular scattering measurements are illustrated on FIG. 10. FIG. 10 shows that by employing the embodiment of FIG. 9, the peak amplitudes of the signals of the angular scattering of polarized light detected from a taped location (the signal labeled “C”) and from an untaped location (the signal labeled “D”) are expected to lie within a factor of about 8 (3-bit dynamic range), and thus within the factor of 256 (8-bit dynamic range) of most inexpensive, commercially available cameras.

Referring again to FIG. 6B, it is noted that when light is reflected from a specular surface near Brewster's angle there is a strong polarization dependence to the reflected light. This is demonstrated graphically on FIG. 6B with reference to a “p” and a “s” polarization. That is, where “p” represents the perpendicular component of polarization and “s” represents the polarization parallel to the surface. On the contrary, when light impinges on a diffuse surface the reflectivity has a substantially weaker dependence on the polarization. Thus, the reflectivity is described as a function of the incident and final polarization according to the following formula:

R=R(εᵢ, ε_{f}, θᵢ); (1)

where: the incident polarization=εᵢ; the final polarization=ε_{f}; and the angle of incidence of the reflected light ray=θᵢ.

Thus, by using εᵢ=“p”, and by varying a polarization in front of the detection fiber to analyze ε_{f}, it is possible to distinguish between the location of the bill covered by tape and the surface not covered by tape. As a result, the polarization contrast C is defined by the formula:

C=1−((R(εᵢ,p)−R(εᵢ,s))/(R(εᵢ,p)+R(εᵢ,s))) (2)

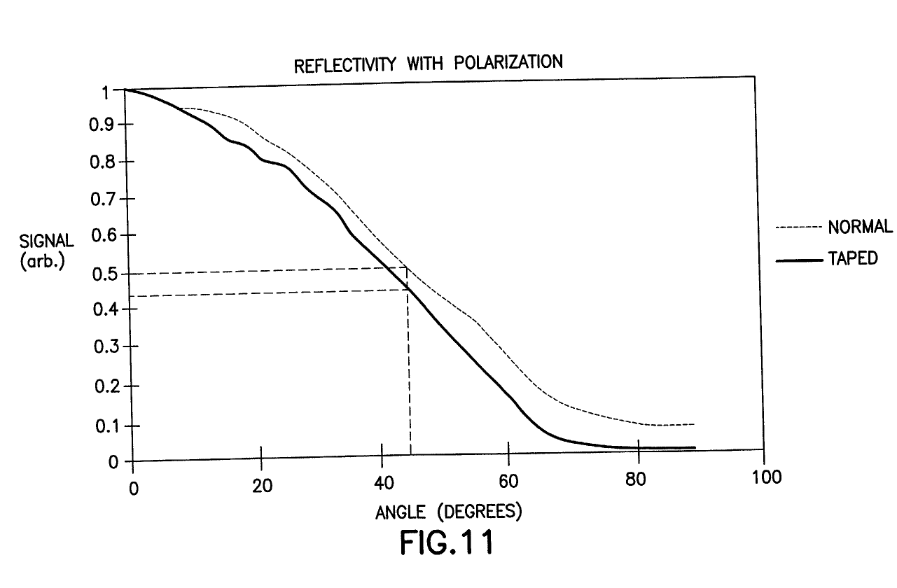

FIG. 11 shows the polarization contrast for a bill 1 which is reflecting a light ray emitted at 45° angle of incidence (AOI). As seen in FIG. 11, the resulting polarization contrast for the normal bill surface locations is about 51%, while the polarization contrast for the taped location is about 44%. While the polarization contrast values change for different AOIs, the basic principle is constant, that the difference in “p” and “s” reflectivities is always greater for the taped, more specular locations and can be correlated therewith.

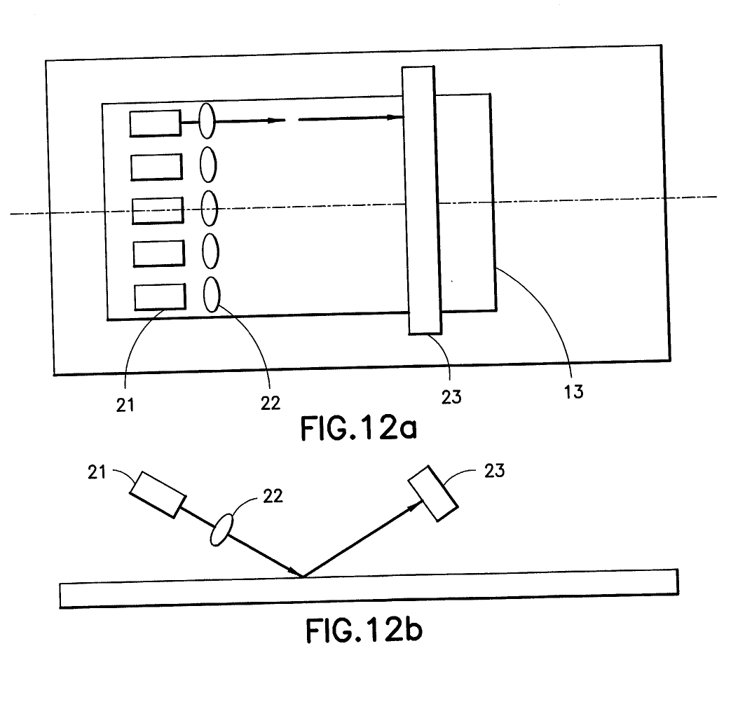

Another embodiment of the apparatus for evaluating the scattering angles of the bills 1 is depicted in FIGS. 12A and 12B. The embodiment of FIGS. 12A and 12B replaces the laser diode 13 of FIGS. 7 and 9 with an electrically scanned array of light emitting diodes (LEDs) 21. Each LED 21 is pulsed at a different time thus allowing different locations on the bill 1 to be evaluated. A transport mechanism (not shown), for example a motor and rollers, pulls the bill 1 across the scanned line in order to map out the bill 1 in two-dimensions. A beam of light emitted by each LED in the array of LEDs 21 is imaged by a lens 22 onto the bill 1 to produce a reflected light beam which is detected by a detector array 23. For example, the detector array 23 is a 32 element photodiode array. In addition to each lens 22, an aperture (not shown) is disposed in front of each LED in the array of the LEDs 21 to give each LED sharp edges in the image plane on the detector array 23. The light emitted from each LED in the array of LEDs 21 hits the reflective surface of the bill 1 in or near the Fourier transform plane of each of the lens 22. The image plane at the detector array 23 is, therefore, the far-field of the beam, which allows direct determination of the angular scattering measurements from the amplitude of the light along the array. As a result, the detector array 23 measures the sharpness of the image of each LED in the array of LEDs 21.

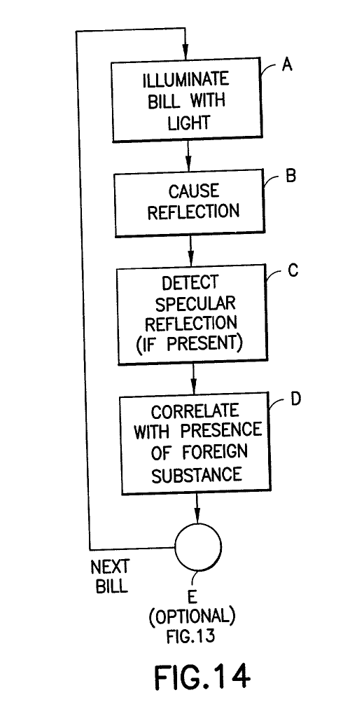

This second embodiment of the invention thus provides a method for detecting a presence of a foreign substance on a surface of the bill 1. Referring to FIG. 14, this method includes steps of (A) illuminating at least a portion of the bill 1 with light; in response to the light, (B) causing either a specular reflection or a diffuse reflection from a surface of the bill; (C) detecting a presence of a specular reflection; and (D) correlating the detected specular reflection with the presence of a foreign substance, such as tape, on the bill. This method may further include a step of (E) detecting the presence of soiling of the bill, as described above and shown in FIG. 13.

It is noted that in the embodiments depicted in FIGS. 7, 9, and 12A, each apparatus is an all-optical embodiment. Additionally, alternate embodiments of the currency inspection apparatus of the present invention may include different light sources, optics, and detectors than those shown in FIGS. 7, 9, 12A, and 12B. For example, the laser diode 13 of FIGS. 7 and 9 may be replaced by other light sources. As shown in FIG. 12A, the laser diode 13 was replaced by the array of LEDs 21. Alternatively, any type of light emitting diode or lamp (incandescent or arc) may be employed. Optics may include a single imaging lens for each light emitter, or a more complex arrangement may be employed. Detector arrays may include single element detectors, or one or two-dimensional arrays such as a Charge-Coupled Device (CCD), a diode array, and a Complimentary Metal-Oxide Semiconductor (CMOS) phototransistor array.

In any of these embodiments the detection of a specular reflection from the surface of the bill 1 maybe considered as fulfilling a bill rejection criterion, causing the bill to be ejected or diverted from the normal paper path.

As was noted above, the bill soiling and wear testing system of FIG. 5 could be combined with the various ones of the embodiments of the tape or other foreign material testing systems of FIGS. 7, 9, 12A and 12B. Separate light sources could be employed, or the same source can be used for performing both functions, either sequentially or simultaneously. In a same manner the same processor 10A can be used for performing both tests, or different processors can be used. Furthermore, the rotation stages shown in FIGS. 7 and 9 could be eliminated by causing the bill 1 of FIG. 5 to pass through a path that imparts a curvature to the bill's surface, thereby facilitating the measurement of the specular/scattering light from the bill's surface.

Thus, while the invention has been particularly shown and described with respect to preferred embodiments thereof, it will be understood by those skilled in the art that changes in form and details may be made therein without departing from the scope and spirit of the invention.

What is claimed is:

1. A method for detecting an amount of soiling of a bill, comprising steps of:
illuminating at least a portion of the bill with excitation light;
in response to the excitation light, emitting response light from the portion of the bill;
detecting an intensity of the emitted response light; and
correlating the detected intensity with an amount of soiling of the bill.

2. A method as in claim 1, and further comprising a step of further correlating the amount of soiling with an amount of wear of the bill.

3. A method as in claim 1, and further comprising a step of detecting a presence of a substantially specular surface region on the bill.

4. A method as in claim 1, wherein the step of emitting comprises a step of generating light having a longer wavelength or a shorter wavelength with a structure embedded within the bill or disposed on or within a surface of the bill.

5. A method as in claim 1, wherein the steps of illuminating and emitting are executed while performing a step of conveying the bill past an optical radiation source and an optical radiation detector.

6. A method as in claim 1, wherein the step of correlating employs a prestored set of data obtained from a set of reference notes.

7. A system for detecting an amount of soiling of a bill, comprising:
an optical source for illuminating at least a portion of the bill with excitation light;
a structure or region within or upon a surface of the bill that is responsive to the excitation light for emitting response light from the portion of the bill;
an optical detector for detecting an intensity of the emitted response light; and
a data processor for correlating the detected intensity with an amount of soiling of the bill.

8. A system as in claim 7, wherein said data processor further correlates the amount of soiling with an amount of wear of the bill.

9. A system as in claim 7, and further comprising means for detecting a presence of a substantially specular surface region on the bill.

10. A system as in claim 7, wherein said structure or region generates response light having a longer wavelength or a shorter wavelength.

11. A system as in claim 7, and further comprising a conveyor for imparting relative motion between the bill and said optical source and said optical detector.

12. A system as in claim 7, and further comprising a memory that is coupled to said data processor, said memory storing a set of intensity data obtained from a set of reference notes.

13. A method of detecting a presence of a foreign substance on a surface of a bill, comprising steps of:
illuminating at least a portion of the bill with light;
in response to the light, causing either a specular reflection or a diffuse reflection from a surface of the bill;
detecting a presence of a specular reflection; and
correlating the detected specular reflection with the presence of a foreign substance on the bill.

14. A method as in claim 13, and further comprising a step of detecting a presence of soiling of the bill.

15. A method as in claim 13, wherein the foreign substance is comprised of transparent or semi-transparent tape.

16. A system for detecting a presence of a foreign substance on a surface of a bill, comprising:
an optical source for illuminating at least a portion of the bill with light and, in response to the light, causing either a specular reflection or a diffuse reflection from a surface of the bill;
an optical detector for detecting a presence of a specular reflection; and
a data processor for correlating the detected specular reflection with the presence of a foreign substance on the bill.

17. A system as in claim 16, wherein said data processor further detects a presence of soiling of the bill.

18. A system as in claim 16, wherein the foreign substance is comprised of transparent or semi-transparent tape.

19. A method of detecting a presence of a foreign substance on a surface of a substrate, comprising steps of:
illuminating at least a portion of the surface of the substrate with light;
detecting a polarization contrast for light reflecting from the surface of the substrate; and
correlating an amount of polarization contrast with a presence of a foreign substance on the substrate.

20. A method as in claim 19, and further comprising a step of detecting a presence of soiling of the substrate.

21. A method as in claim 19, wherein the foreign substance is comprised of transparent or semi-transparent tape.

22. A method as in claim 19, wherein the substrate is comprised of an item of currency.

23. A system for detecting a presence of a foreign substance on a surface of a substrate, comprising:
means for illuminating at least a portion of the surface of the substrate with light;
means for detecting a polarization contrast for light reflecting from the surface of the substrate; and
means for correlating an amount of polarization contrast with a presence of a foreign substance on the substrate.

24. A system as in claim 23, and further comprising means for detecting a presence of soiling of the substrate.

25. A system as in claim 23, wherein the foreign substance is comprised of transparent or semi-transparent tape.

26. A system as in claim 23, wherein the substrate is comprised of an item of currency.

27. A system as in claim 23, wherein said means for illuminating comprises at least one polarizer.
